(19) United States
(12) Patent Application Publication
(10) Pub. No.: US 2009/0051209 A1
(43) Pub. Date: Feb. 26, 2009

(54) Conveyor trailer

(76) Inventors: Kevin J. Pierce, Grand Forks, ND (US); Michael J. Pierce, Grand Forks, ND (US); Randy Dufault, East Grand Forks, MN (US)

Correspondence Address: ROBERT E. KLEVE, 1103-24TH AVE S., GRAND FORKS, ND, 58201, US

(21) Appl. No.: 11/894,957

(22) Filed: Aug. 22, 2007

(51) Int. Cl. B60P 1/30

(52) U.S. Cl. 298/14

(57) ABSTRACT

The invention comprises a dump trailer for dispensing materials onto receiving objects from different heights comprising a box and main frame with the box tiltable to raise one end of the box at an angle to the main frame. The box has a first and second conveyor with the first conveyor powered to travel along the bottom of the box towards the one end of the box to convey material in the box towards the one end of the box when the box is tiltable at an angle. The second conveyor is raisable with the box at the one end of the box with means to maintain the second conveyor parallel to the main frame and generally parallel to the ground.

This invention relates to a dump trailer having dual conveyors.

It is an object of the invention to provide a novel dual conveyor dump trailer wherein the a first conveyor in a box conveys material onto a second conveyor from the box and the second conveyor is maintained generally parallel to a frame regardless of the angle or height of the dump trailer.

It is another object of the invention to provide a novel apparatus which will maintain the dispensing conveyor substantially parallel to the other members of the trailer wherein those other members are substantially parallel to the ground so that the dispensing conveyor parallelism will provide less likelihood of the material dispensed spilling off to one side of the dispensing conveyor regardless of the height of the dispensing conveyor.

Briefly stated the invention comprises a dual conveyor dump trailer pivotally mounted to a main frame with a first conveyor mounted along the bottom of the dump trailer to convey material from the trailer out through the front opening in the dump trailer, a second conveyor mounted to the forward end of the dump trailer beneath the forward end of the first conveyor to receive material conveyed from the first conveyor, said dump trailer being pivotally mounted to said main frame to pivot upward at an angle to said main frame, said second conveyor having means to pivotally support said second conveyor on said dump trailer so that when said trailer is pivoted at an angle to the main frame said second conveyor will be maintained parallel to said main frame.

Further objects and advantages of the invention will become apparent as the description proceeds and when taken in conjunction with the accompanying drawings wherein:

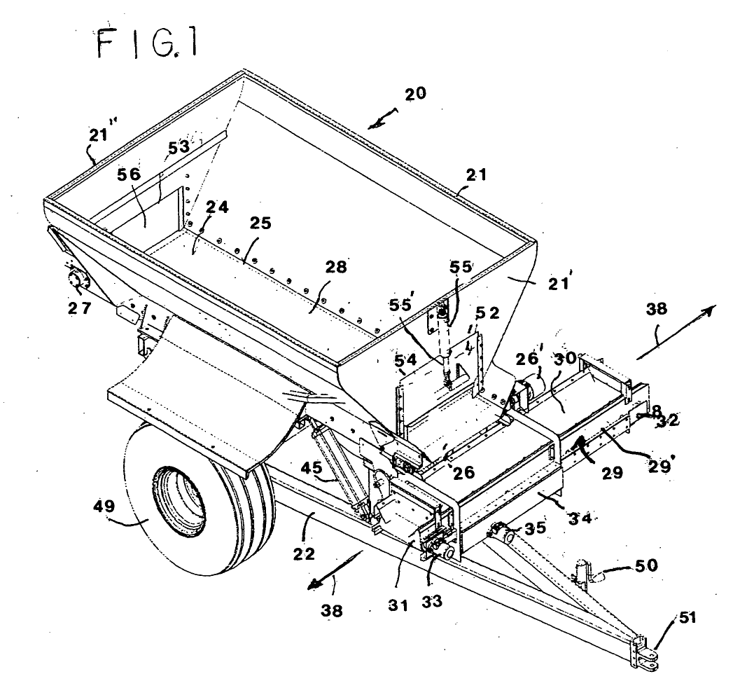

FIG. 1 is a right frontal perspective of the dump trailer conveyor apparatus with the trailer pivoted downward to a substantially parallel position to the main frame.

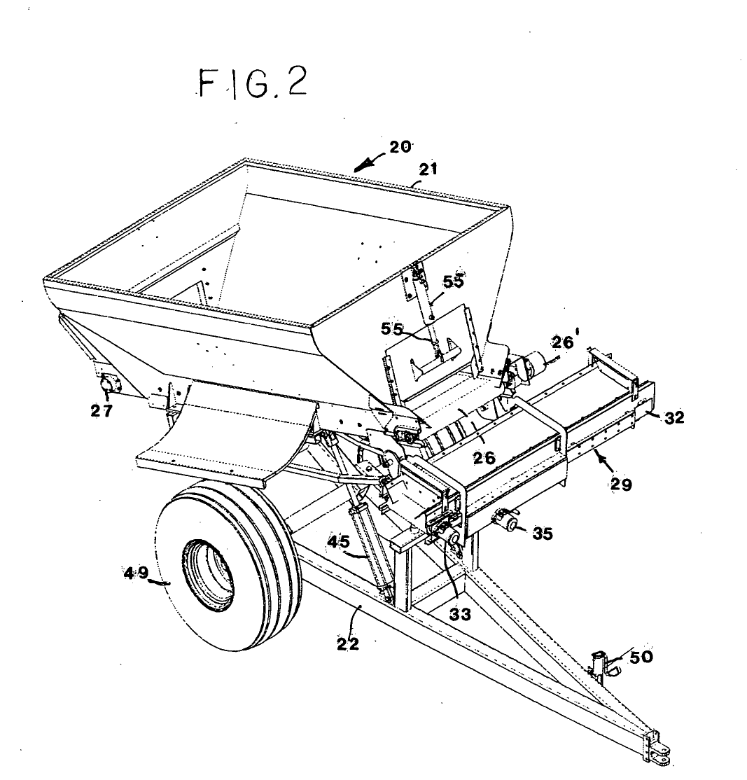

FIG. 2 is a right frontal perspective view of the dump trailer pivoted upward to a angular position and with the second conveyor through its leverage connection to the main frame maintaining the second conveyor substantially parallel to the main frame.

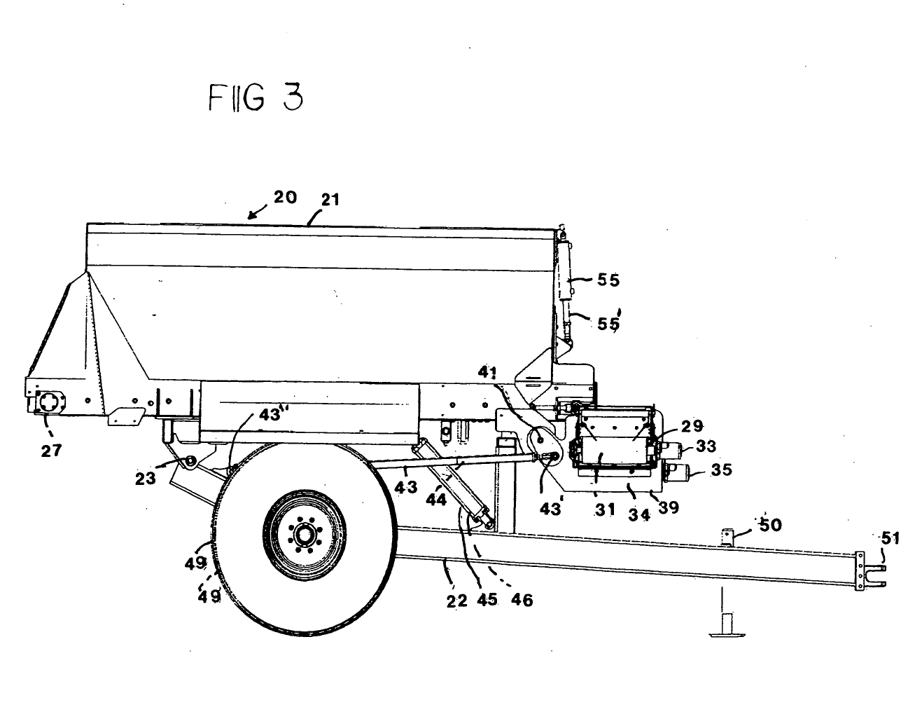

FIG. 3 is a side elevational view of the dump trailer conveyor apparatus with the dump trailer in its lower position substantially parallel to the main frame.

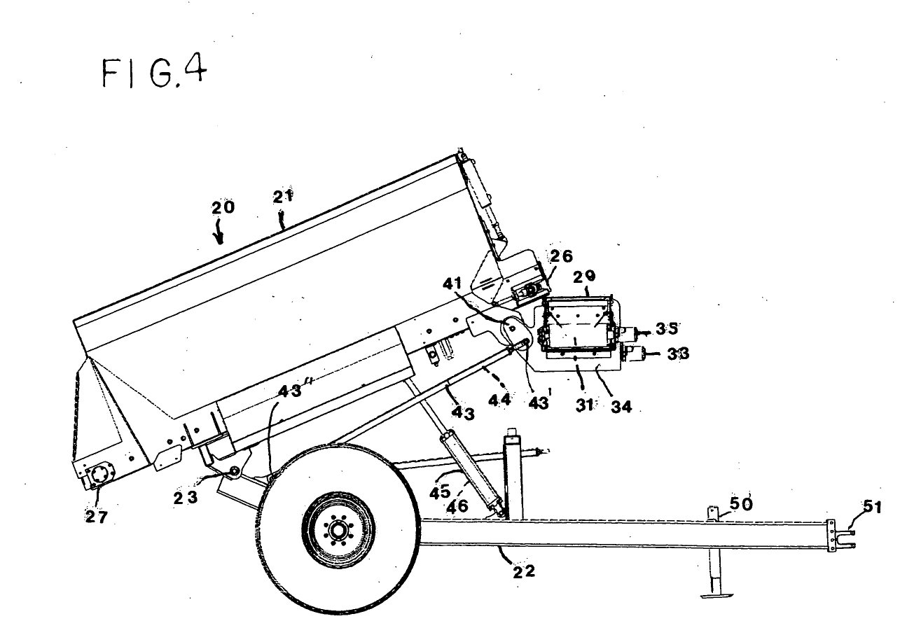

FIG. 4 is a side elevation view of the dump trailer conveyor apparatus with the dump trailer pivoted upward relative to the frame and with the second conveyor having a pivotal connection to the main frame to maintain its parallel position to the main frame when the dump trailer is pivoted upward at an angle to the main frame.

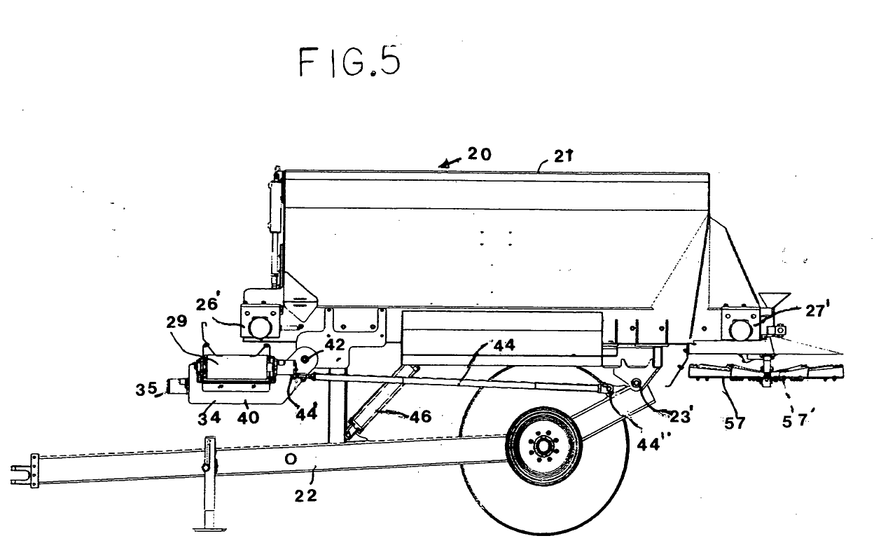

FIG. 5 is a left side elevational view of the dump trailer conveyor apparatus

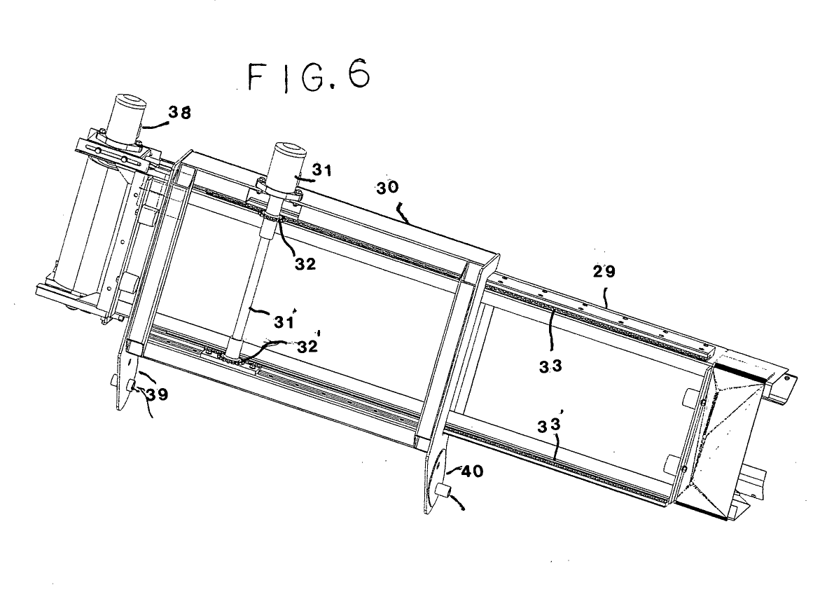

FIG. 6 is a bottom view of the second conveyor and drive connection in from the conveyor guide to the second conveyor.

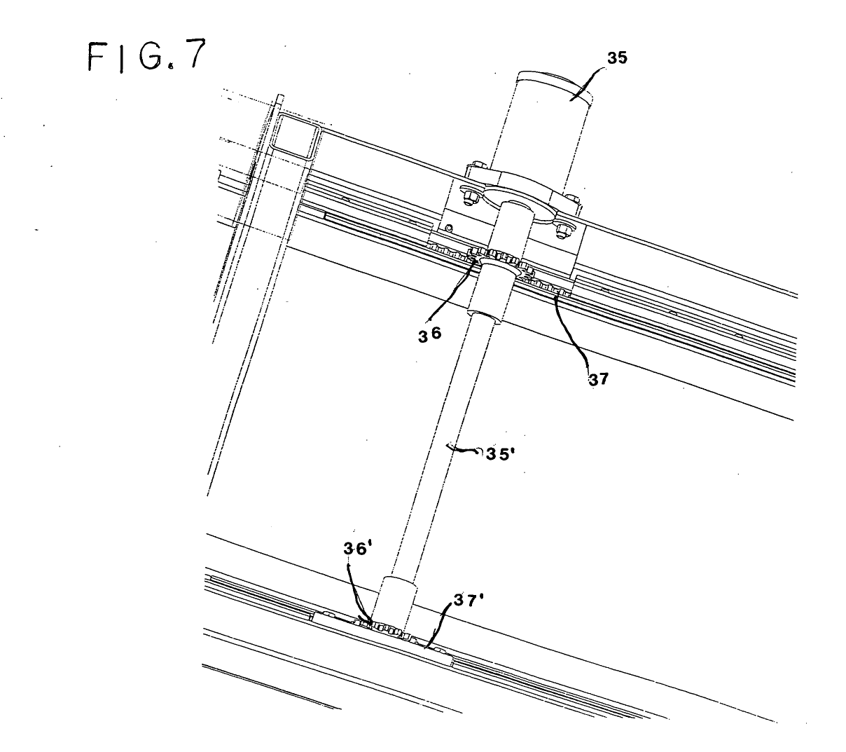

FIG. 7 is an enlarged fragmentary view of the bottom of the second conveyor and the conveyor guide drive connection to the second conveyor.

Referring more particularly to the drawings, the dual conveyor apparatus 20 has a dump trailer bin or box 21 pivotally mounted to a main frame 22 at horizontal coaxial pivot points 23 and 23′. The first conveyor 24 is mounted along the open bottom 25 of the dump trailer bin 21. The first conveyor 24 has a frame 24′ and has a front roller 26 and a rear roller 27 mounted on the conveyor frame 24′ with a conveyor belt 28 mounted about rollers 26 and 27. The front roller 26 is powered by a front motor 26′. The rear roller 27 is powered by a rear motor 27′. The motors 26′ and 27′ rotate the front roller 26 and the rear roller 27, respectively, which rotate the belt 28 along the conveyor frame 24′ about the front and rear rollers 26 and 27, at the remote front and rear ends 21′ and 21″ of the dump trailer bin 20.

The second conveyor 29 has a conveyor belt 30 mounted about end rollers 31 and 32 on a frame 29′. The roller 31 is powered by a reversible motor 33 to drive the belt 30 in either direction about the rollers. The second conveyor 29 is supported in a channel 34. The second conveyor 29 and its conveyor frame 29′ is slidably mounted along a conveyor channel 34 to slide longitudinally in the conveyor channel from one side or the other. The frame of the second conveyor 29′ is powered in the channel by a motor 35, which motor rotates a shaft 35′. The shaft 35′ has a pair of gears 36 and 36′ fixed to the shaft which gears when rotated by the shaft 35′ engage tracks 37 and 37′ along the lower forward and rearward edges of the bottom of the second conveyor frame 29′ to power the movement of the second conveyor on its frame in the channel 34 from the one lateral side or to the other lateral side of the dump trailer bin 20 as indicated by the arrows 38. The motor 35 is reversible so that the second conveyor 29 can be driven in either direction on the channel.

The channel 34 for supporting the second conveyor has a pair of pivotally mounted side portions 39 and 40 on each side of the bin. The side portions 39 and 40 are pivotally mounted to the bin at pivot points 41 and 42, so the channel 34 operates to raise and lower the second raise and lower the channel and second conveyor 29 therein, by pivoting the channel about the pins 41 and 42 forming the pivot points. The side portions 39 and 40 of the channel 34 are pivotally mounted on pin 41 on one side of the bin to the bin, and on other side of the bin to the bin by the pin 42 at the forward end of the bin. The pins 41 and 42 are arranged coaxially to one another so as to pivot the channel 34 coaxially about their horizontal axis at the forward remote end of the trailer bin 21.

The channel member has a pair of parallel linkage rods 43 and 44 on each side of the bin 21. The linkage rods 43 and 44 pivotally mounted at their one end to the opposing side portions 39 and 40 respectively of the conveyor channel at pivots pins 43′ and 44′. The parallel rod members 43 and 44 are pivotally mounted at their other ends to the opposite sides of the main frame 22 at pivots pins 43″ and 44″ respectively.

The bin 21 may be pivoted upward at an angle about the pivots by actuation of a pair of hydraulic cylinders 45 and 46 with their pistons pivotally connected to the main frame by their cylinders at pivot points 47 and 47′ to the frame with the pistons pivotally connected to the bin at pivot points 48 and 48′. The dump trailer bin when raised upward about pivots 23 and 23′ and through the connection of parallel rod members 43 and 44 will cause the conveyor channel 34 to pivot about its pivotally mounted connection pins 41 and 42 to maintain the channel and thereby the second conveyor 29 parallel to the main frame 22 as it is raised or lowered as illustrated in FIG. 4.

The parallel linkage bars act to pivot the conveyor channel 34 and thereby the second conveyor about the pivots 41 and 41′ downward relative to the bin as the bin is pivoted upward about the about the main frame to maintain the second conveyor and conveyor belt 30 of the second conveyor parallel to the main frame as illustrated in FIGS. 1 and 3 in their lower position and illustrated in their raised position in FIGS. 2 and 4.

The parallel linkage operation of the channel member for the second conveyor enables the second conveyor to be maintained parallel to the main frame 22. The main frame has a pair of wheels 49 and 49′ mounted to the rear of the frame so that the frame is generally parallel to the ground or may be positioned parallel to the ground by suitable support means under the forward end of the main frame 22 such as a jack 50. This enables the apparatus to be operated while the unit is stationary. A trailer hitch 51 is provided at the forward end of the main frame for towing the dump trailer along the ground when operating the trailer to dispense material in a path along the ground.

Maintaining the main frame parallel enables the second conveyor to be parallel to the ground so that material when dumped on to the top of the belt 30 of the second conveyor from the first conveyor to be sufficiently level to the main frame 22 and level to the ground so that the material will not gravitate off the belt 30 of second conveyor 29 when powered by the second conveyor. Thus the second conveyor 29 may be raised and lowered to different heights by the pivoting of the dump trailer bin 21 while its parallelism is maintained to the main frame 22 and material dispensed on either side of the apparatus and either end of the second conveyor as indicated by the arrows 38 and 38′. Materials may be dispensed on either side of the remote ends of the second conveyor 29 as the motor 35 driving the shaft 35′ to drive the second conveyor frame in the channel is reversible so that the second conveyor may be driver to either side of the device. This maintaining the parallel positions provides less likelihood of gravitational spillage off the belt 30 on either side of the conveyor 29. the rearward end. The opening 52 has a slidable cover 54 which is controlled by hydraulic cylinder 55 which has a piston 55′ movable to telescope downward to close the cover to a selected position. Immediately adjacent the belt of the first conveyor the cover 54 may be drawn upward by hydraulic retraction of the piston 55′. The rear opening 53 will be normally closed by a panel 56 and remain closed while tilting the bin at an angle.

It is customary to provide a pair of spinners 57, 57′ on the rear of the bin 21, such as shown in FIG. 5, for spinning and spreading materials distributed out the rear opening 53 in the bin, when desired, by running the first conveyor belt 28 rearward toward the rear opening 53 in the bin.

It will be obvious that various changes and departures may be made to the invention without departing from its spirit and scope thereof and accordingly is not intended that the invention be limited to that specifically described in the specification or as illustrated in the drawings but only as set forth in the appended claims wherein:

1. A dual conveyor dump trailer, said trailer having a dump box, a first and second conveyor, and a main frame, said first conveyor being drivably mounted along the bottom of the dump box with said dump box having a bottom opening so that material may travel out the box and onto the first conveyor, a second conveyor mounted to the forward end of the first conveyor and, a channel slidably supporting said second conveyor at the forward end of the first conveyor, said first conveyor mounted along the bottom of the dump box to convey material from the box out through the front opening in the dump box, a channel pivotally mounted to the forward end of the box to slidably support the second conveyor beneath the forward end of the first conveyor to receive material conveyed from the first conveyor, said dump box being pivotally mounted to said main frame, said box being pivotally mounted on said main frame to pivot upward at an angle to said main frame, said channel having means to pivotally support said second conveyor on said dump box so that when said box is pivoted at an angle to the main frame said second conveyor will be maintained parallel to said main frame.

2. A dual conveyor dump trailer, said trailer having a dump box, a first and second conveyor, and a main frame, said box being pivotally mounted on said main frame to pivot one end of said box upward from a position at least generally parallel to the main frame upward to an angular position relative to the main frame, a channel support mechanism pivotally mounted to the one end of the dump box, a second conveyor slidably mounted in said channel member beneath the one end of the first conveyor, linkage means between the main frame and the channel member providing a parallel linkage so as to pivotally maintain the channel member and the second conveyor in substantially parallel relation to the main frame so that if the main frame is substantially parallel to the ground the second conveyor will, irrespective of the angle and height of the box to which the box may be tilted so that any material conveyed on to the second conveyor from the first conveyor will have less likelihood of gravitating off the side of the second conveyor.

3. A dual conveyor dump trailer, said trailer having a dump box, a first and second conveyor and a main frame, said box being movable from a position generally parallel to the main frame to an angular position relative to the main frame, a channel support mechanism mounted to the forward end of the box and said second conveyor movable and said channel member and said second conveyor being movable with said box, said channel member being slidable mounted in said channel member, linkage means between the main frame and channel member of a parallel character so as to maintain a channel member and the second conveyor in parallel relation to the main frame when said box is moved to said angular position so that the second conveyor will, irrespective of the angle and height of the box, will be maintained substantially parallel to the main frame so that material conveyed onto the second conveyor from the first conveyor will have less likelihood of gravitating off the side of the second conveyor.

4. A dual conveyor dump trailer according to claim 3 wherein wheels are provided at the rear of the main frame for supporting the apparatus, jack means are provided at the forward end of the frame to adjust the main frame into greater parallelism with the ground when operating the apparatus from a stationary location.

5. A dual conveyor dump trailer according to claim 3 wherein hitch means are provided at the forward end of the main frame for attaching and towing the trailer behind a towing vehicle.
